(19) United States
(12) Patent Application Publication
(10) Pub. No.: US 2008/0317030 A1
(43) Pub. Date: Dec. 25, 2008

(54) Method of creating address forwarding table in ethernet ring network

(75) Inventors: June Koo Rhee, Daejeon (KR); Jin Sung Im, Ulsan (KR)

Correspondence Address: WELLS ST. JOHN P.S., 601 W. FIRST AVENUE, SUITE 1300, SPOKANE, WA, 99201, US

(73) Assignee: ICU Research and Industrial Cooperation Group

(21) Appl. No.: 12/009,819

(22) Filed: Jan. 22, 2008

(30) Foreign Application Priority Data
Jun. 22, 2007 (KR) 10-2007-0061604
Oct. 26, 2007 (KR) 10-2007-0108391

(51) Int. Cl. H04L 12/28

(52) U.S. Cl. 370/392

(57) ABSTRACT

Provided is a method of creating an address forwarding table in an Ethernet ring network. The method includes the steps of: broadcasting, at each Ethernet node, a ring learning frame having information for measuring cost in the frame's payload in both directions; and receiving, at each Ethernet node, two ring learning frames transferred from different Ethernet nodes and recording a ring learning frame containing information having the minimum cost in the Ethernet node's address forwarding table. Accordingly, by creating an intelligent address forwarding table, it is possible to efficiently prevent a loop without conventionally using a closed loop, and to rapidly transfer a frame through an optimal path.

### BACKGROUND OF THE INVENTION

1. Field of the Invention

The present invention relates to a method of creating an address forwarding table in an Ethernet ring network, and more particularly, to a method of creating an efficient address forwarding table in an Ethernet ring network that does not make a closed port.

2. Description of the Related Art

Conventional methods of creating an address forwarding table, e.g., Filtering Database (FDB), are implemented by logically or physically selecting a closed link or a closed port to prevent an infinite loop, and so on.

The conventional methods can easily prevent an infinite loop when several Ethernet rings are connected. However, a ring topology is changed into a spanning tree structure not having a loop, and thus overall network efficiency deteriorates in comparison with a case in which all links are activated.

In addition, in consideration of the size of subnetworks connected with a ring node, closing of one port or one link seriously deteriorates overall network efficiency. Also, when a fault occurs in one link, address forwarding tables of all nodes are initialized, and new address forwarding tables are created. Thus, until all source addresses are learned, a larger amount of frames than that of a normal state are distributed within a network.

In consideration of the capacity of a subnetwork, the conventional technology that closes one port or one link in an Ethernet ring network cannot use an optimal path, and instead constitutes a linear tree-shaped network, thereby considerably deteriorating overall network efficiency.

### SUMMARY OF THE INVENTION

In consideration of the above problems, it is an object of the present invention to provide a method of creating an address forwarding table in an Ethernet ring network, which solves a problem in which an inefficient address forwarding table is created in the Ethernet ring network.

It is another object of the present invention to provide a method of creating an address forwarding table in an Ethernet ring network, which creates an intelligent address forwarding table without using a closed port and can thus prevent a loop and rapidly transfer a frame through an optimal path.

In order to achieve the above objects, according to one aspect of the present invention, a method of creating an address forwarding table in an Ethernet ring network in which a plurality of Ethernet nodes are connected in a ring shape is provided, the method comprising the steps of: broadcasting, at each Ethernet node, a ring learning frame having information for measuring cost in a payload in both directions; and receiving, at each Ethernet node, two ring learning frames transferred from different Ethernet nodes and recording a ring learning frame containing information having the minimum cost in the Ethernet node's address forwarding table.

Here, each Ethernet node receiving the ring learning frame may search for a source address of the received ring learning frame in the Ethernet node's address forwarding table, and when the source address does not exist in the address forwarding table, record a port and the source address of the received ring learning frame in the address forwarding table and record a cost value included in the payload of the ring learning frame in the Ethernet node's cost table.

Each Ethernet node receiving the ring learning frame may search for the source address of the received ring learning frame in the Ethernet node's address forwarding table, compare a cost value included in the payload of the ring learning frame with a cost value recorded in the Ethernet node's cost table when the source address exists in the address forwarding table, delete the source address and the cost value respectively recorded in the Ethernet node's address forwarding table and cost table, and record the source address and the cost value of the received ring learning frame when the cost value included in the payload of the ring learning frame is smaller than the cost value recorded in the Ethernet node's cost table.

The information for measuring cost may include information on time and the number of hops.

According to another aspect of the present invention, a method of creating an address forwarding table in an Ethernet ring network in which a plurality of Ethernet nodes having a subnetwork including a large number of Ethernet stations are connected in a ring shape is provided, the method comprising the step of: when a destination address of a frame transferred from a subnetwork of one Ethernet node exists in an address forwarding table of each Ethernet node, but a source address does not exist, recording, at each Ethernet node, the source address as a new entry in the Ethernet node's address forwarding table and transferring the frame through a port corresponding to the destination address recorded in the Ethernet node's address forwarding table so that the frame is transferred to a subnetwork of an Ethernet node having the destination address.

According to still another aspect of the present invention, a method of creating an address forwarding table in an Ethernet ring network in which a plurality of Ethernet nodes having a subnetwork including a large number of Ethernet stations are connected in a ring shape is provided, the method comprising the steps of: when a destination address of a frame transferred from a subnetwork of one Ethernet node exists in some address forwarding tables of the Ethernet nodes, recording and encapsulating, at an Ethernet node whose address forwarding table does not have the destination address, an address of the corresponding Ethernet node as a source address of the transferred frame and multicasting as a destination address in the transferred frame, and then transferring the encapsulated frame through one port; decapsulating, at an Ethernet node receiving the encapsulated frame, the encapsulated frame, checking the destination address, and when the destination address of the initial frame does not exist in the corresponding Ethernet node's address forwarding table, broadcasting the frame to a subnetwork connected with the corresponding Ethernet node and re-encapsulating and transferring the frame to a next node; and after decapsulating and transferring, at an Ethernet node whose address forwarding table has the destination address, the encapsulated frame to a subnetwork corresponding to the destination address, generating, at the subnetwork having the destination address, a new Media Access Control (MAC) learning frame in which the destination address is recorded as a source address, and the address of the initial Ethernet node recorded as the source address of the encapsulated frame is recorded as a destination address, and transferring the MAC learning frame in a direction of a port recorded in the corresponding Ethernet node's address forwarding table so that the MAC learning frame reaches the subnetwork having the destination address.

According to yet another aspect of the present invention, a method of creating an address forwarding table in an Ethernet ring network in which a plurality of Ethernet nodes having a subnetwork including a large number of Ethernet stations are connected in a ring shape is provided, the method comprising the steps of: when a destination address of a frame transferred from a subnetwork of one initial Ethernet node does not exist in an address forwarding table of each Ethernet node, recording and encapsulating, at each Ethernet node, an address of the initial Ethernet node as a source address and multicasting as a destination address in the transferred frame, and then transferring the encapsulated frame through one port; decapsulating, at an Ethernet node receiving the encapsulated frame, the encapsulated frame, checking the destination address, and when the destination address of the initial frame does not exist in an address forwarding table of the Ethernet node, broadcasting the frame to a subnetwork connected with the Ethernet node and re-encapsulating and transferring the frame to a next node; and when the frame is transferred to the initial Ethernet node corresponding to the source address, discarding and terminating, at the initial Ethernet node, the transferred frame.

According to yet another aspect of the present invention, a recording medium storing a program for executing the above-described method of creating an address forwarding table in an Ethernet ring network is provided.

### BRIEF DESCRIPTION OF THE DRAWINGS

FIG. 1 is a conceptual diagram illustrating a method of creating an address forwarding table in an Ethernet ring network according to a first exemplary embodiment of the present invention;

FIGS. 2A to 2C are flow charts of a method of creating an address forwarding table in an Ethernet ring network according to an exemplary embodiment of the present invention;

FIG. 3 is a conceptual diagram illustrating a method of creating an address forwarding table in an Ethernet ring network according to a second exemplary embodiment of the present invention;

FIG. 4 is a conceptual diagram illustrating a method of creating an address forwarding table in an Ethernet ring network according to a third exemplary embodiment of the present invention; and

FIG. 5 is a conceptual diagram illustrating a method of creating an address forwarding table in an Ethernet ring network according to a fourth exemplary embodiment of the present invention.

### DESCRIPTION OF THE PREFERRED EMBODIMENTS

Hereinafter, preferred embodiments of the present invention will be described in detail with reference to the accompanying drawings.

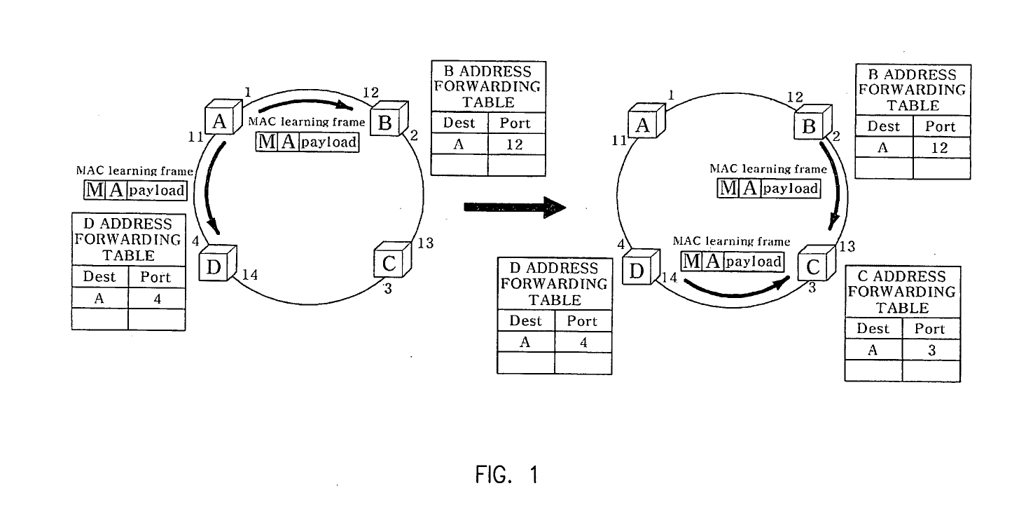

FIG. 1 is a conceptual diagram illustrating a method of creating an address forwarding table in an Ethernet ring network according to a first exemplary embodiment of the present invention.

Referring to FIG. 1, an Ethernet ring network applied to the first exemplary embodiment of the present invention comprises first to fourth Ethernet nodes A to D, which are connected in a ring shape.

The first Ethernet node A multicasts a ring learning frame or a Media Access Control (MAC) learning frame including information for measuring cost to the second and fourth Ethernet nodes B and D.

Since the thus-transferred ring learning frame is transferred in both directions, each Ethernet node receives two ring learning frames. For example, when the third Ethernet node C receives two ring learning frames, it compares cost values of the two ring learning frames with each other and records a ring learning frame having the minimum cost value in its own address forwarding table.

When the ring learning frame is transferred to each Ethernet node in this way to complete the learning, an infinite loop is not generated by all address forwarding tables, and an intelligent address forwarding table is created, whereby data is transferred through an optimal path using only the minimum cost value.

Meanwhile, the ring learning frame contains information on a Source Address (SA), time and the number of hops, etc., and the information on time and the number of hops, etc., is included in payload entries.

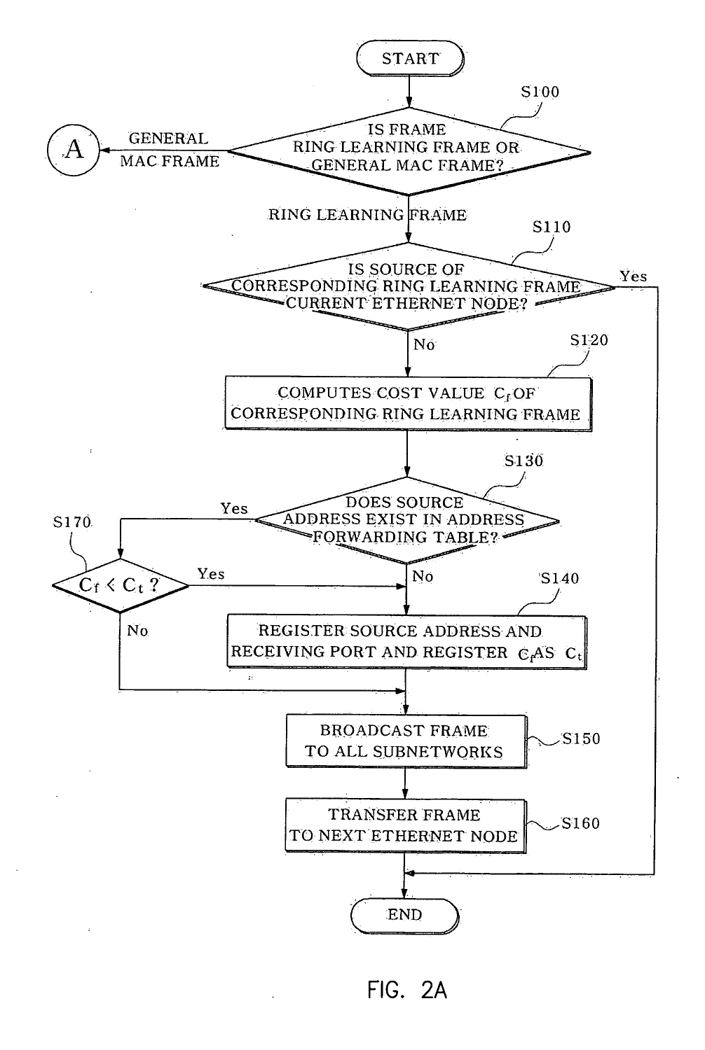

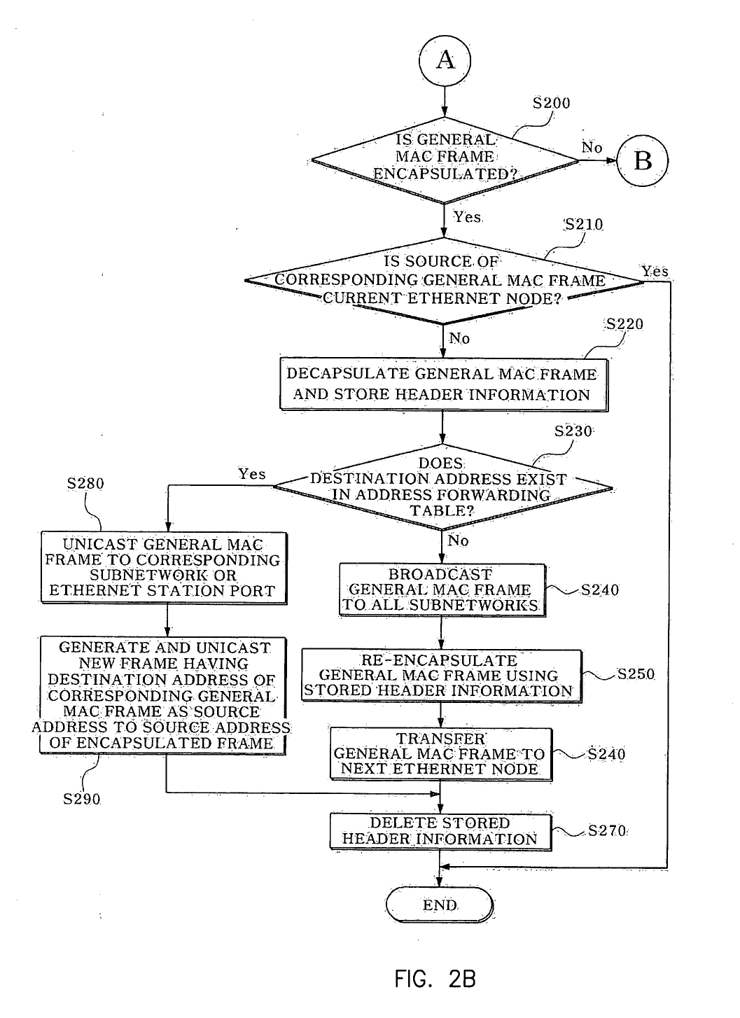

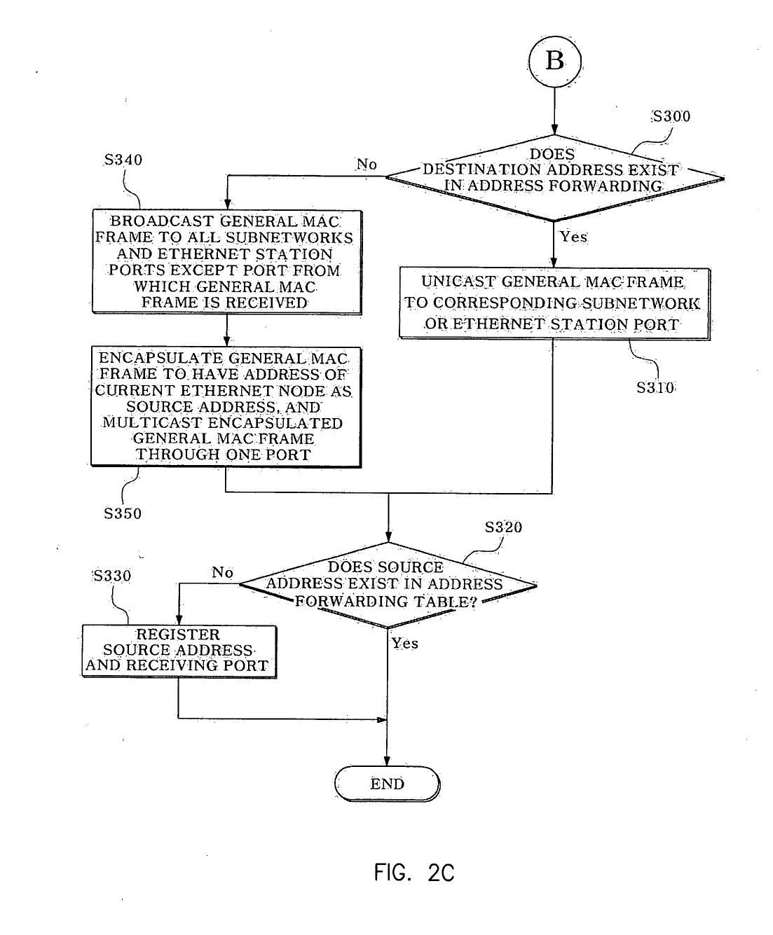

FIGS. 2A to 2C are flow charts of a method of creating an address forwarding table in an Ethernet ring network according to an exemplary embodiment of the present invention, showing a process of creating an address forwarding table when a ring learning frame for creating an address forwarding table or a general MAC frame is received.

Referring to FIGS. 2A to 2C, generation and transfer of an initial ring learning frame is as follows. After generating a general MAC frame without a payload, each Ethernet node designates multicasting as a Destination Address (DA) and its own address as an SA.

Subsequently, by designating a ring learning frame as a type identification (ID) of the frame and broadcasting the frame in both directions, each Ethernet node obtains information on all networks connected with the Ethernet ring network, e.g., an input/output port number, subnetwork information, etc., using the broadcasted frame and stores the information in its memory.

Therefore, it is possible to smoothly transfer a next-transferred ring learning frame or general frame, and each Ethernet node can readily distinguish a port corresponding to a ring node from a port corresponding to a subnetwork.

After finishing the initial preparation process for smoothly transferring a frame, each Ethernet node checks the type ID of a received frame and determines whether the frame is a ring learning frame or a general MAC frame (step 100).

When it is determined in step 100 that the frame received by each Ethernet node is a ring learning frame, the Ethernet node determines whether a source of the ring learning frame is the Ethernet node itself (step 110). When the source is the Ethernet node, the Ethernet node finishes a ring learning process or a MAC learning process.

On the other hand, when the source of the ring learning frame is not the Ethernet node itself, the Ethernet node computes a cost value C_{f} of the ring learning frame (step 120) and then determines whether information on an SA of the ring learning frame exists in its own address forwarding table (step 130).

When it is determined in step 130 that the information on the SA of the ring learning frame does not exist in its own address forwarding table, the Ethernet node registers the SA and a receiving port number of the ring learning frame in its own address forwarding table and registers the computed cost value C_{f} as a cost value Cₜ in its own cost table (step 140).

Subsequently, the Ethernet node broadcasts the ring learning frame through a port connected to all subnetworks (step 150), and then transfers the ring learning frame to a next Ethernet node (step 160).

Meanwhile, when it is determined in step 130 that the information on the SA of the ring learning frame exists in the address forwarding table, the Ethernet node compares the cost value C_{f} of the ring learning frame with a cost value Cₜ recorded in its own cost table (step 170).

When it is determined in step 170 that the cost value C_{f} of the ring learning frame is larger than the cost value Cₜ recorded in the Ethernet node's cost table, the process proceeds to step 150. On the other hand, when the cost value C_{f} of the ring learning frame is smaller than the cost value Cₜ recorded in the Ethernet node's cost table, the process proceeds to step 140.

Meanwhile, when it is determined in step 100 that the frame received by each Ethernet node is a MAC learning frame other than a ring learning frame, procedure (A) is performed.

In procedure (A), as illustrated in FIG. 2B, the Ethernet node determines whether the received general MAC frame is encapsulated by MAC-in-MAC technology (step 200).

When it is determined in step 200 that the received general MAC frame is encapsulated by the MAC-in-MAC technology, the Ethernet node determines whether a source of the general MAC frame is the Ethernet node itself (step 210). When the source is the Ethernet node itself, the Ethernet node finishes the ring learning process.

On the other hand, when the source of the general MAC frame is not the Ethernet node itself, the Ethernet node decapsulates the encapsulated general MAC frame and stores MAC-in-MAC header information (step 220), and then determines whether information on a DA of the general MAC frame exists in its own address forwarding table (step 230). When the information on the DA does not exist in the address forwarding table, the Ethernet node broadcasts the general MAC frame to all subnetworks (step 240).

Subsequently, the Ethernet node re-encapsulates the decapsulated general MAC frame based on the stored MAC-in-MAC header information using the MAC-in-MAC technology (step 250), and then transfers the re-encapsulated general MAC frame to a next Ethernet node (step 260). After this, the stored MAC-in-MAC header information is deleted (step 270).

Meanwhile, when it is determined in step 230 that the information on the DA of the general MAC frame exists in the address forwarding table, the Ethernet node unicasts the general MAC frame to the corresponding subnetwork or Ethernet station port (step 280).

Subsequently, the Ethernet node generates a new MAC frame having the DA of the general MAC frame as an SA and unicasts the new MAC frame to the SA of the initial general MAC frame encapsulated by the MAC-in-MAC technology (step 290). After this, the process proceeds to step 270.

Meanwhile, when it is determined in step 200 that the received general MAC frame is not encapsulated by the MAC-in-MAC technology, procedure (B) is performed.

In procedure (B), as illustrated in FIG. 2C, the Ethernet node determines whether information on a DA of the general MAC frame exists in its own address forwarding table (step 300). When the information on the DA exists in the address forwarding table, the Ethernet node unicasts the general MAC frame to the corresponding subnetwork or Ethernet station port (step 310).

Subsequently, the Ethernet node determines whether information on an SA of the general MAC frame exists in its own address forwarding table (step 320). When the information on the SA exists in the address forwarding table, the Ethernet node finishes the ring learning process.

On the other hand, when it is determined in step 320 that the information on the SA of the general MAC frame does not exist in the address forwarding table, the Ethernet node registers the SA and a receiving port number of the general MAC frame in the address forwarding table (step 330), and then finishes the ring learning process.

Meanwhile, when it is determined in step 300 that the information on the DA of the general MAC frame does not exist in the address forwarding table, the Ethernet node broadcasts the general MAC frame to all subnetworks and Ethernet station ports except a port through which the general MAC frame is received (step 340).

Subsequently, the Ethernet node encapsulates the general MAC frame having its own address as an SA using the MAC-in-MAC technology and multicasts the encapsulated general MAC frame through one of Ethernet ports (step 350). After this, the process proceeds to step 320.

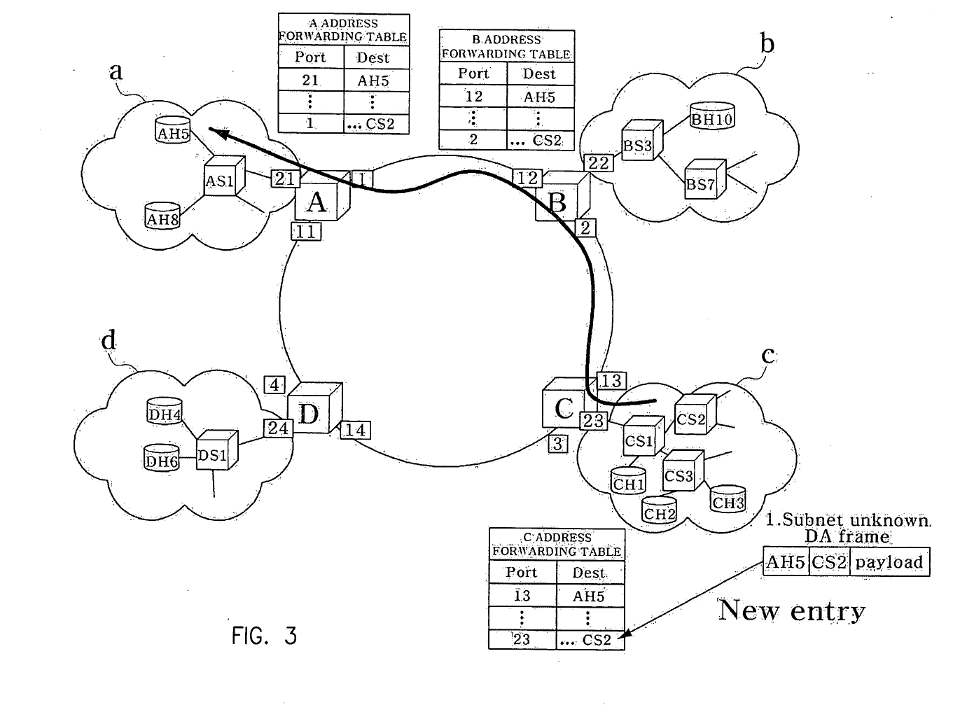

FIG. 3 is a conceptual diagram illustrating a method of creating an address forwarding table in an Ethernet ring network according to a second exemplary embodiment of the present invention, conceptually showing a process of creating an address forwarding table when address forwarding tables of respective Ethernet nodes A to D have information on a DA of a frame transferred from one subnetwork but no information on an SA of the frame.

Referring to FIG. 3, an Ethernet ring network employed by the second exemplary embodiment of the present invention includes first to fourth Ethernet nodes A to D, which are connected with each other in a ring shape.

In addition, the first to fourth Ethernet nodes A to D have first to fourth subnetworks a to d including a plurality of Ethernet stations connected in a tree shape, respectively.

When a frame that has an Ethernet station having a MAC address CS2 in the third subnetwork c of the third Ethernet node C as a source and an Ethernet station having a MAC address AH5 in the first subnetwork a of the first Ethernet node A as a destination is transferred, an address forwarding table of the third Ethernet node C has information on the DA, i.e., AH5, but no information on the SA, i.e., CS2.

In this case, the third Ethernet node C records the information on the SA, i.e., CS2, as a new entry in its own address forwarding table and transfers the frame through a port 13 corresponding to the DA, i.e., AH5, recorded in the address forwarding table.

In the same way, the second and first Ethernet nodes B and A record the information on the SA, i.e., the MAC address CS2, as a new entry in their address forwarding tables and successfully finish transferring the frame to the Ethernet station having the DA, i.e., the MAC address AH5.

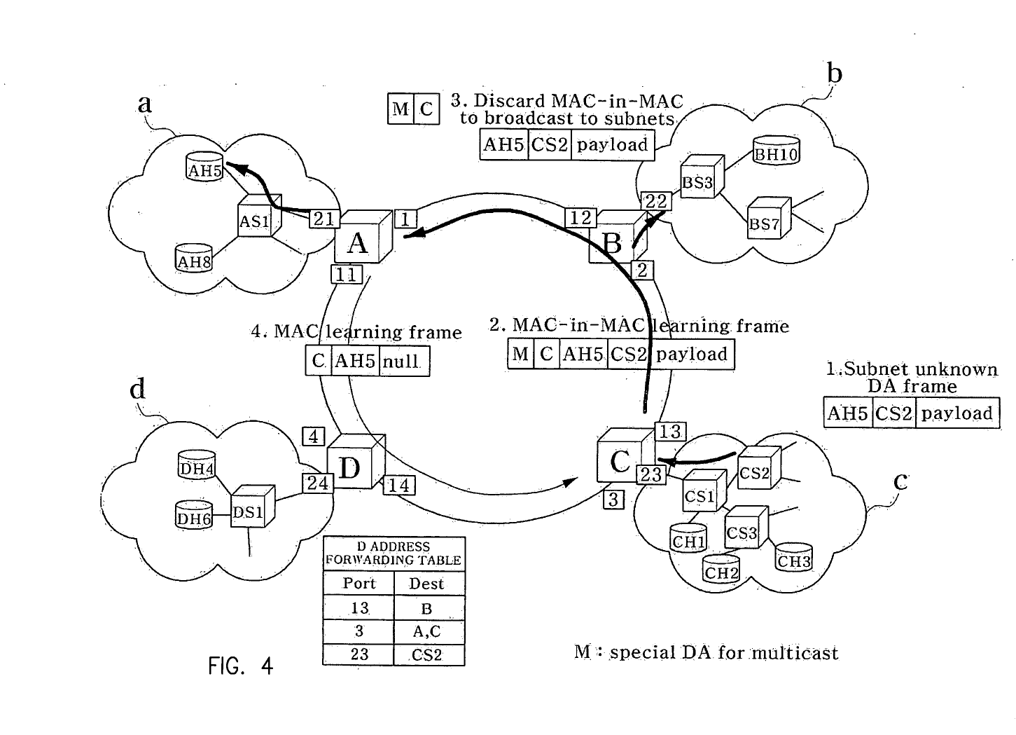

FIG. 4 is a conceptual diagram illustrating a method of creating an address forwarding table in an Ethernet ring network according to a third exemplary embodiment of the present invention, conceptually showing a process of creating an address forwarding table when some address forwarding tables of respective Ethernet nodes A to D have information on a DA of a frame transferred from one subnetwork.

Referring to FIG. 4, an Ethernet ring network employed by the third exemplary embodiment of the present invention has the same constitution as the Ethernet ring network employed by the above-described second exemplary embodiment of the present invention.

When a frame that has an Ethernet station having a MAC address CS2 in the third subnetwork c of the third Ethernet node C as a source and an Ethernet station having a MAC address AH5 in the first subnetwork a of the first Ethernet node A as a destination is transferred, information on the DA, i.e., AH5, may not exist in an address forwarding table of the third Ethernet node C. In this case, the third Ethernet node C records and encapsulates its own address as an SA and multicasting as a DA in the transferred frame using the MAC-in-MAC technology defined by Institute of Electrical and Electronics Engineers (IEEE), and then transfers the encapsulated frame through one port.

The second Ethernet node B receiving the frame transferred to a next Ethernet node of the Ethernet ring network using the MAC-in-MAC technology decapsulates the encapsulated frame and checks the DA.

Here, when the DA does not exist in an address forwarding table of the second Ethernet node B, the second Ethernet node B broadcasts the frame to the second subnetwork b connected with the second Ethernet node B, re-encapsulates the frame using the MAC-in-MAC technology and transfers the re-encapsulated frame to a next Ethernet node, i.e., the third Ethernet node C. In addition, due to the MAC-in-MAC encapsulation, learning of the SA does not occur.

When the DA, i.e., the MAC address AH5, of the frame exists in an address forwarding table of an Ethernet node, i.e., the first Ethernet node A, while such a process is repeated, the first Ethernet node A decapsulates and transfers the encapsulated frame to the MAC address AH5 of the first subnetwork a that is the DA.

Here, the first Ethernet node A does not transfer the frame to a next Ethernet node using the MAC-in-MAC technology. After this, an Ethernet station having the DA, i.e., the MAC address AH5 of the first subnetwork, generates a new MAC learning frame in which the DA, i.e., AH5, is recorded as an SA, and an address of the initial Ethernet node, i.e., the third Ethernet node C, recorded as the SA by the MAC-in-MAC technology is recorded as a DA, and transfers the new MAC learning frame in the direction of a port recorded in the address forwarding table of the first Ethernet node A. When the new MAC learning frame arrives at the destination, a general MAC learning process is completed.

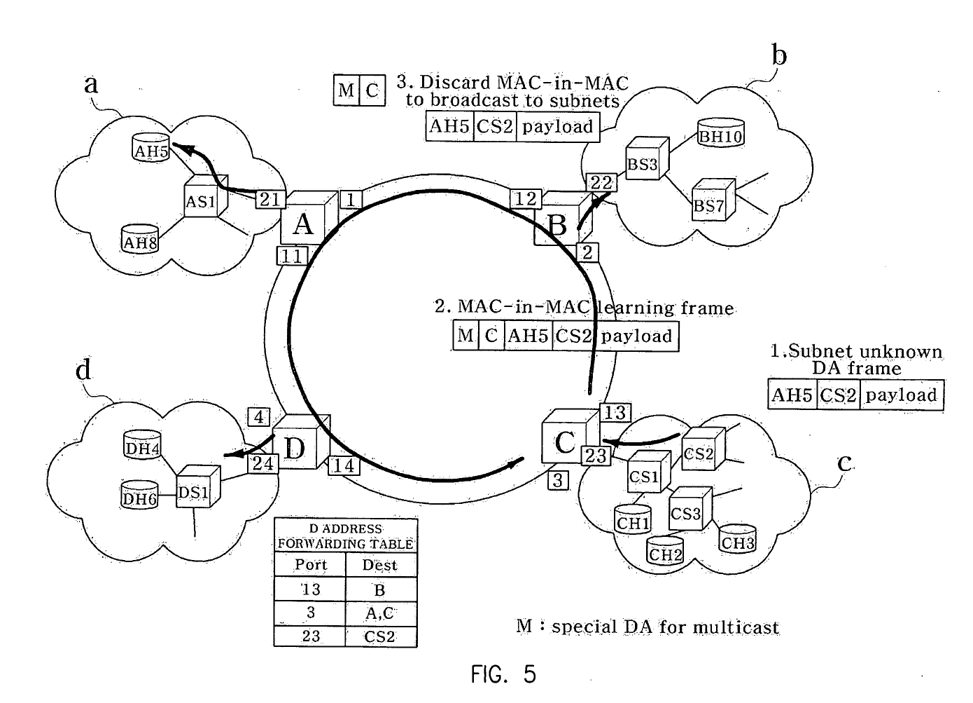

FIG. 5 is a conceptual diagram illustrating a method of creating an address forwarding table in an Ethernet ring network according to a fourth exemplary embodiment of the present invention, conceptually showing a process of creating an address forwarding table when address forwarding tables of respective Ethernet nodes A to D do not have information on a DA of a frame transferred from one subnetwork.

Referring to FIG. 5, an Ethernet ring network employed by the fourth exemplary embodiment of the present invention has the same constitution as the Ethernet ring network employed by the above-described second exemplary embodiment of the present invention.

When a frame that has an Ethernet station having a MAC address CS2 in the third subnetwork c of the third Ethernet node C as a source and an Ethernet station having a MAC address AH5 in the first subnetwork a of the first Ethernet node A as a destination is transferred, information on the DA, i.e., AH5, may not exist in any address forwarding tables of the first to fourth Ethernet nodes A to D. In this case, the third Ethernet node C records and encapsulates its own address as an SA and multicasting as a DA in the frame using the general MAC-in-MAC technology, and then transfers the frame through one port.

The second Ethernet node B receiving the frame transferred to a next Ethernet node of the Ethernet ring network using the MAC-in-MAC technology decapsulates the encapsulated frame and checks the DA.

Here, when the DA does not exist in the address forwarding table of the second Ethernet node B, the second Ethernet node B broadcasts the frame to the second subnetwork b connected with the second Ethernet node B itself, re-encapsulates the frame using the MAC-in-MAC technology and transfers the frame to a next Ethernet node, i.e., the third Ethernet node C.

When the frame returns to an Ethernet node, i.e., the third Ethernet node C, whose address forwarding table has the SA, i.e., CS2, of the initial frame while such a process is repeated, the third Ethernet node C discards the frame and terminates the MAC frame. In this case, a general MAC learning process does not occur, but the frame transferred to the destination node is successfully transferred due to a characteristic that the frame is broadcast to a subnetwork.

The above-described principles of creating an intelligent address forwarding table according to the present invention will now be briefly described. In an Ethernet ring network, each Ethernet node broadcasts a ring learning frame to create an address forwarding table. The ring learning frame contains, for example, information on an SA, time, the number of hops, and so on.

An Ethernet node receiving the ring learning frame compares cost values based on, for example, the information on an SA, time, the number of hops, etc., and records an SA of a frame having the minimum cost value in its own address forwarding table. When two ring learning frames transferred from one Ethernet node in both directions of the ring network return to the Ethernet node itself, other Ethernet nodes' address forwarding tables on the Ethernet node are all completed. When all Ethernet nodes perform such a process, the intelligent address forwarding table is completed.

Meanwhile, creation of an address forwarding table in a subnetwork will now be described in brief. Using Ethernet Operation, Administration and Maintenance (OAM) defined by International Telecommunications Union-Telecommunication Standardization sector (ITU-T), Ethernet nodes constitute a Maintenance Entity Group (MEG). Each Ethernet node of the Ethernet ring network has a subnetwork.

According to Ethernet MAC, the number of subnetworks is currently limited to about 250 due to a standard 1500-byte Maximum Transfer Unit (MTU) and 6-byte ring learning frames. The ring learning frames contain a MAC address of a subnetwork, which is not contained as an SA but contained in a payload.

When a DA does not exist in an address forwarding table of an Ethernet node, a MAC frame is transferred to a subnetwork by the MAC-in-MAC technology defined by IEEE.

According to the MAC-in-MAC technology, an address of an Ethernet node other than an address of a subnetwork is recorded as an SA in a frame, and the frame is transferred in only one direction. In addition, when the frame arrives at an Ethernet whose address is recorded as the SA in the frame, it is discarded to prevent an infinite loop and optimal ring learning.

As described above, to efficiently manage a ring network for a metro Ethernet service or a carrier-grade Ethernet service, the present invention can create an efficient address forwarding table without using a closed port or a closed link.

In addition, the present invention can create an efficient address forwarding table for an Ethernet ring topology and a subnetwork. Also, the present invention overcomes a disadvantage of a conventional method wherein a network is inefficiently used because one link is inactivated by a closed port, and activates all links, thus considerably increasing network use efficiency.

Here, in order to create such an efficient address forwarding table in an Ethernet ring network, a frame transferred by each Ethernet node according to an address forwarding table must not generate an infinite loop. This is referred to as an “active management method”, whereby an administrator or a routing protocol manages a content of the address forwarding table of each Ethernet node or prevents an infinite loop by using a combination of such a management method and an Ethernet address learning method. In this way, the efficient address forwarding table enables use of an optimal path, thereby obtaining high efficiency.

Meanwhile, the method of creating an address forwarding table in an Ethernet ring network according to an exemplary embodiment of the present invention can be implemented in a computer-readable recording medium in the form of computer code. The computer-readable recording medium may be any recording device storing data that can be read by computer systems.

For example, the computer-readable recording medium may be a read-only memory (ROM), a random-access memory (RAM), a compact disk read-only memory (CD-ROM), a magnetic tape, a hard disk, a floppy disk, a mobile storage device, a nonvolatile memory (flash memory), an optical data storage device, and so on. Also, the recording medium may be carrier waves, e.g., transmission over the Internet.

In addition, the computer-readable recording medium may be distributed among computer systems connected via a communication network and stored in the form of a code that can be read and executed by a de-centralized method.

According to the inventive method of creating an address forwarding table in an Ethernet ring network described above, all links in the Ethernet ring network are activated, and an optimal path to a destination is available using a cost table. Therefore, it is possible to obtain higher efficiency than technology that uses a closed port and prevent a loop using an intelligent address forwarding table.

In addition, according to the present invention, it is possible to create an efficient address forwarding table for an Ethernet ring topology and a subnetwork. Also, a disadvantage of a conventional method wherein a network is inefficiently used because one link is inactivated by a closed port is overcome, and all links are activated, thus considerably increasing network use efficiency.

Exemplary embodiments of the present invention have been disclosed herein and, although specific terms are employed, they are used and are to be interpreted in a generic and descriptive sense only and not for purposes of limitation. Accordingly, it will be understood by those of ordinary skill in the art that various changes in form and details may be made without departing from the spirit and scope of the present invention as set forth in the following claims.

What is claimed is:

1. A method of creating an address forwarding table in an Ethernet ring network in which a plurality of Ethernet nodes are connected in a ring shape, the method comprising the steps of:
broadcasting, at each Ethernet node, a ring learning frame having information for measuring cost in a payload in both directions; and
receiving, at each Ethernet node, two ring learning frames transferred from different Ethernet nodes and recording a ring learning frame containing information having the minimum cost in the Ethernet node's address forwarding table.

2. The method of claim 1, wherein each Ethernet node receiving the ring learning frame searches for a source address of the received ring learning frame in the Ethernet node's address forwarding table, and when the source address does not exist in the address forwarding table, records a port and the source address of the received ring learning frame in the address forwarding table and records a cost value included in the payload of the ring learning frame in the Ethernet node's cost table.

3. The method of claim 1 or 2, wherein each Ethernet node receiving the ring learning frame searches for the source address of the received ring learning frame in the Ethernet node's address forwarding table, compares a cost value included in the payload of the ring learning frame with a cost value recorded in the Ethernet node's cost table when the source address exists in the address forwarding table, deletes the source address and the cost value respectively recorded in the Ethernet node's address forwarding table and cost table, and records the source address and the cost value of the received ring learning frame when the cost value included in the payload of the ring learning frame is smaller than the cost value recorded in the Ethernet node's cost table.

4. The method of claim 1, wherein the information for measuring cost includes information on time and a number of hops.

5. A method of creating an address forwarding table in an Ethernet ring network in which a plurality of Ethernet nodes comprising a subnetwork comprised of a large number of Ethernet stations are connected in a ring shape, the method comprising the step of:
when a destination address of a frame transferred from a subnetwork of one Ethernet node exists in an address forwarding table of each Ethernet node, but a source address does not exist, recording, at each Ethernet node, the source address as a new entry in the Ethernet node's address forwarding table and transferring the frame through a port corresponding to the destination address recorded in the Ethernet node's address forwarding table so that the frame is transferred to a subnetwork of an Ethernet node having the destination address.

6. A method of creating an address forwarding table in an Ethernet ring network in which a plurality of Ethernet nodes comprising a subnetwork comprised of a large number of Ethernet stations are connected in a ring shape, the method comprising the steps of:
when a destination address of a frame transferred from a subnetwork of one Ethernet node exists in some address forwarding tables of the Ethernet nodes, recording and encapsulating, at an Ethernet node whose address forwarding table does not have the destination address, an address of the corresponding Ethernet node as a source address of the transferred frame and multicasting as a destination address in the transferred frame, and then transferring the encapsulated frame through one port;
decapsulating, at an Ethernet node receiving the encapsulated frame, the encapsulated frame, checking the destination address, and when the destination address of the initial frame does not exist in the corresponding Ethernet node's address forwarding table, broadcasting the frame to a subnetwork connected with the corresponding Ethernet node and re-encapsulating and transferring the frame to a next node; and
after decapsulating and transferring, at an Ethernet node whose address forwarding table has the destination address, the encapsulated frame to a subnetwork corresponding to the destination address, generating, at the subnetwork having the destination address, a new Media Access Control (MAC) learning frame in which the destination address is recorded as a source address, and the address of the initial Ethernet node recorded as the source address of the encapsulated frame is recorded as a destination address, and transferring the MAC learning frame in a direction of a port recorded in the Ethernet node's address forwarding table so that the MAC learning frame reaches the subnetwork having the destination address.

7. A method of creating an address forwarding table in an Ethernet ring network in which a plurality of Ethernet nodes comprising a subnetwork including a large number of Ethernet stations are connected in a ring shape, the method comprising the steps of:
when a destination address of a frame transferred from a subnetwork of one initial Ethernet node does not exist in an address forwarding table of each Ethernet node, recording and encapsulating, at each Ethernet node, an address of the initial Ethernet node as a source address and multicasting as a destination address in the transferred frame, and then transferring the encapsulated frame through one port;
decapsulating, at an Ethernet node receiving the encapsulated frame, the encapsulated frame, checking the destination address, and when the destination address of the initial frame does not exist in an address forwarding table of the Ethernet node, broadcasting the frame to a subnetwork connected with the Ethernet node and re-encapsulating and transferring the frame to a next node; and
when the frame is transferred to the initial Ethernet node corresponding to the source address, discarding and terminating, at the initial Ethernet node, the transferred frame.

8. A recording medium storing a computer program for executing the above-described method of any one of claims 1 to 7.
